(19) United States
(12) Patent Application Publication
(10) Pub. No.: US 2025/0030936 A1
(43) Pub. Date: Jan. 23, 2025

(54) ADAPTIVE CAMERA PREVIEW FRAME RATE

(71) Applicant: QUALCOMM Incorporated, San Diego, CA (US)

(72) Inventors: Sumit GEMINI, Delhi (IN); Gaurav GAGRANI, Hyderabad (IN); Raghavendra Reddy MANDIPALLE, Hyderabad (IN); Nikhil Kumar KANSAL, San Diego, CA (US)

(21) Appl. No.: 18/356,472

(22) Filed: Jul. 21, 2023

(51) Int. Cl. H04N 23/63; G06T 1/20; G06T 7/20

(52) U.S. Cl. CPC H04N 23/632; G06T 1/20; G06T 7/20; G06T 2207/10016

(57) ABSTRACT

Systems and techniques are described herein for an adaptive camera preview frame rate. For example, a computing device can compare a current image frame of a scene with a previous image frame of the scene. The computing device can determine whether the scene comprises an idle scene scenario based on comparing the current image frame with the previous image frame. The computing device can adjust a preview frame rate based on determining that the scene comprises an idle scene scenario

### FIELD

This application is related to image processing. In some examples, aspects of this application relate to systems and techniques for providing an adaptive camera preview frame rate.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Electronic devices are increasingly equipped with camera hardware to capture image frames, such as still images and/or video frames, of a scene. A camera is a device that receives light and captures image frames (e.g., still images or video frames) using an image sensor. In some examples, a camera may include one or more processors, such as image signal processors (ISPs), that can process one or more image frames captured by an image sensor. For example, a raw image frame captured by an image sensor can be processed by an image signal processor (ISP) of a camera to generate a preview of the image prior to the final display of the image.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for providing an adaptive camera preview frame rate. According to at least one illustrative example, an apparatus for processing image data is provided. The apparatus includes at least one processor coupled to at least one memory device and configured to: compare a current image frame of a scene with a previous image frame of the scene; determine whether the scene comprises an idle scene scenario based on comparing the current image frame with the previous image frame; and adjust a preview frame rate based on determining that the scene comprises an idle scene scenario.

In another illustrative example, a method for processing image data is provided. The method includes: comparing, by one or more image processors of a camera, a current image frame of a scene with a previous image frame of the scene; determining, by the one or more image processors, whether the scene comprises an idle scene scenario based on comparing the current image frame with the previous image frame; and adjusting, by the one or more image processors, a preview frame rate based on determining that the scene comprises an idle scene scenario.

In another illustrative example, a non-transitory computer-readable storage medium is provided that includes instructions stored thereon which, when executed by at least one processor, causes the at least one processor to: compare a current image frame of a scene with a previous image frame of the scene; determine whether the scene comprises an idle scene scenario based on comparing the current image frame with the previous image frame; and adjust a preview frame rate based on determining that the scene comprises an idle scene scenario.

In another illustrative example, an apparatus for processing image data is provided. The apparatus includes: means for comparing, by one or more image processors of a camera, a current image frame of a scene with a previous image frame of the scene; means for determining, by the one or more image processors, whether the scene comprises an idle scene scenario based on comparing the current image frame with the previous image frame; and means for adjusting, by the one or more image processors, a preview frame rate based on determining that the scene comprises an idle scene scenario.

Aspects generally include a method, apparatus, system, computer program product, non-transitory computer-readable medium, user device, user equipment, wireless communication device, and/or processing system as substantially described with reference to and as illustrated by the drawings and specification.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Examples of various implementations are described in detail below with reference to the following figures:

FIG. 1 is a block diagram illustrating an example architecture of an image capture and processing system, in accordance with some examples.

FIG. 2 is a block diagram illustrating an example of interactions between components of an image capture and processing system, in accordance with some examples.

FIG. 3 is a block diagram of an example device that may employ an adaptive camera preview frame rate, in accordance with some examples.

FIG. 4 is a block diagram showing the operation of an image signal processor pipeline, in accordance with some examples.

FIG. 5 is a block diagram illustrating an example of data flow in a camera system, in accordance with some examples.

FIG. 6 is a block diagram illustrating an example system for data processing, in accordance with some examples.

FIG. 7 is a block diagram illustrating an example of a system that may employ an adaptive camera preview frame rate, in accordance with some examples.

FIG. 8 is a is a block diagram illustrating an example of a system that may employ an adaptive camera preview frame rate, where the diagram is showing examples of frame rates within the system, in accordance with some examples.

FIG. 9 is a flow diagram illustrating an example of a process for an adaptive camera preview frame rate, in accordance with some examples.)

FIG. 10 is a diagram illustrating an example of a system for implementing certain aspects described herein, in accordance with some examples.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

As previously mentioned, the increasing versatility of digital camera products has allowed digital cameras to be implemented into a wide array of devices and has expanded their use to different applications. In one or more examples, phones, drones, cars, computers, televisions, and many other devices today are frequently equipped with camera devices. The camera devices allow users to capture images and/or video, which includes frames of images, from any system equipped with a camera device. The images and/or videos can be captured for recreational use, professional photography, surveillance, and automation, among other applications. Moreover, camera devices are often equipped with specific functionalities for modifying images or creating artistic effects on the images. For example, many camera devices are equipped with image processing capabilities for generating different effects on captured images.

Electronic devices are increasingly equipped with camera hardware to capture image frames, such as still images and/or video frames, of a scene. As used herein, the terms “image,” “frame,” and “image frame” are used interchangeably. A camera is a device that receives light and captures image frames, in the form of still images or video frames, using an image sensor. In one or more examples, a camera may include one or more processors, such as ISPs, that can process one or more image frames captured by an image sensor. For example, a raw image frame captured by an image sensor can be processed by an ISP of a camera to generate a preview of the image prior to the final display of the image.

In many camera implementations, a preview frame rate for the preview of an image is set to a default setting, such as 60 frames per second (FPS), regardless of the level of activity within a scene being captured. For example, when the scene involves a scenario with a high level of movement, such as scenario including a fast-moving object (e.g., a scene with a speeding car), the default preview frame rate setting can be appropriate to sufficiently capture the fast moving object in the image preview. However, when the scene involves an idle scene scenario, such as a scenario of capturing a sunset or a static scene, the default preview frame rate can be excessive. For example, a lower preview frame rate setting of 10 FPS may be sufficient to capture the idle scene scenario. As such, for idle scene scenarios, the default preview frame rate setting can be wasteful of camera resources (e.g., computing resources, storage bandwidth, etc.) and power. As such, in the camera industry today, there is a need for an adaptive camera preview frame rate to conserve the camera resources and power.

Accordingly, systems, apparatuses, processes (also referred to as methods), and computer-readable media (collectively referred to herein as “systems and techniques”) are described herein for providing an adaptive camera preview frame rate. For the systems and techniques, a system can adapt its preview frame rate according to the level of activity within the scene being captured.

In one or more aspects, during operation for the systems and techniques, one or more sensors (e.g., which are configured to capture image data, such as light and color) of a camera can obtain (e.g., capture) a current image frame of a scene (e.g., at a sensor frame rate). The scene may include a high level of movement, such as a scene including a fast moving object (e.g., a speeding car), or may include an idle scene scenario. After the one or more sensors of the camera have obtained the current image frame of the scene, one or more processors of the camera, such as an image signal processor (ISP), can determine one or more statistics for the current image frame of the scene. In one or more examples, the one or more processors can run a 3A algorithm to determine the statistics, which can include different types of statistics. The 3 A algorithm can determine statistics associated with autofocus, statistics associated with auto white balance (AWB), and/or statistics associated with auto exposure.

The one or more processors of the camera can compare the statistics of the current image frame of the scene with statistics of a previous image frame of the scene (e.g., which was captured by the one or more sensors of the camera a short time prior to the capturing of the current image frame) to determine whether or not the scene includes an idle scene scenario. In one illustrative example, the one or more processors of the camera may determine that the scene includes an idle scene scenario when the difference in one or more of the statistics of the current image frame with one or more of the statistics of the previous image frame is below a statistics threshold value for one or more of the statistics. In one or more examples, each of the different types of statistics can have a respective statistics threshold. Conversely, the one or more processors of the camera may determine that the scene does not include an idle scene scenario when the difference in one or more of the statistics of the current image frame with one or more of the statistics of the previous image frame is equal to or above the statistics threshold value for one or more of the statistics.

When the one or more processors of the camera determines that the scene includes in idle scene scenario, the one or more processors of the camera can adjust a preview frame rate for the camera from a default preview frame rate (e.g., 60 FPS) to a lower preview frame rate (e.g., 10 FPS, 30 FPS, etc.). For example, the one or more processors can receive the previous image frame and the current image frame (among other image frames in some cases) at the sensor frame rate and can output the preview frames to a memory device (e.g., Double Data Rate (DDR) Synchronous Dynamic Random Access Memory (SDRAM), also referred to as DDR or DDR memory) at the adjusted preview frame rate, which can save memory bandwidth (e.g., by storing 10 frames, 30 frames, etc. each second, instead of the full 60 frames each second). A display can then read the previous image frame and the current image frame (and in some cases the other image frames) from the memory device at a display frame rate. The display frame rate can be the same as the adjusted preview frame rate or can be a higher frame rate (e.g., 60 FPS). In such cases, the rate at which image frames are output from the one or more processors for processing by an encoder (e.g., for compressing the image frames for storage in a file system) can be different from the adjusted preview frame rate, such as at a rate equal to the sensor frame rate (e.g., 60 FPS). However, when the one or more processors of the camera determine that the scene does not include in idle scene scenario, the one or more processors of the camera can maintain the preview frame rate for the camera at the default preview frame rate (e.g., 60 FPS).

Further aspects of the systems and techniques are described with respect to the figures.

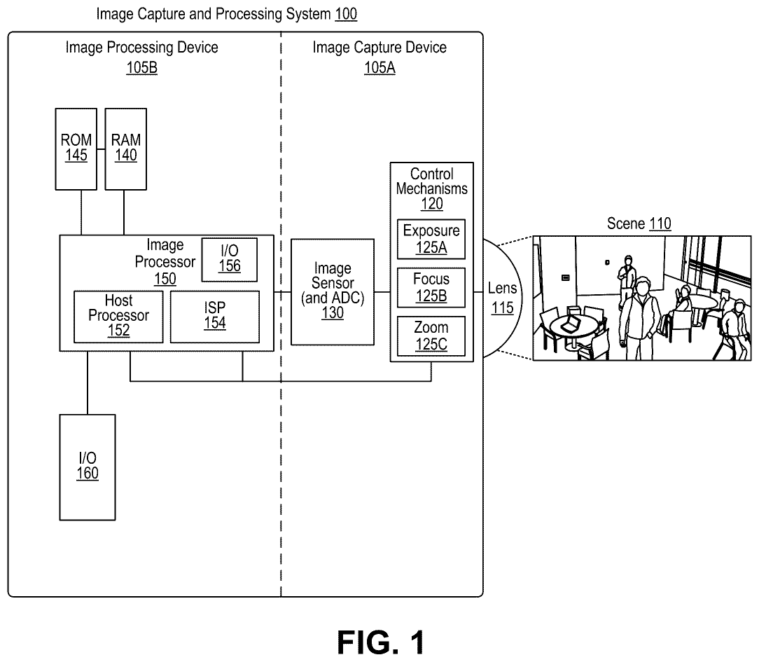

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly May include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 1510 discussed with respect to the computing system 1500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface), an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1525, read-only memory (ROM) 145/1520, a cache 1512, a memory unit 1515, another storage device 1530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 1535, any other input devices 1545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

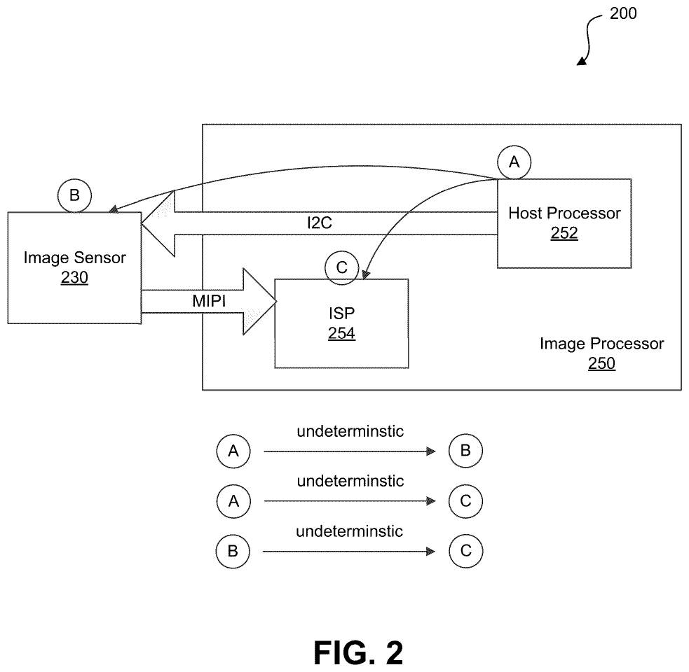

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

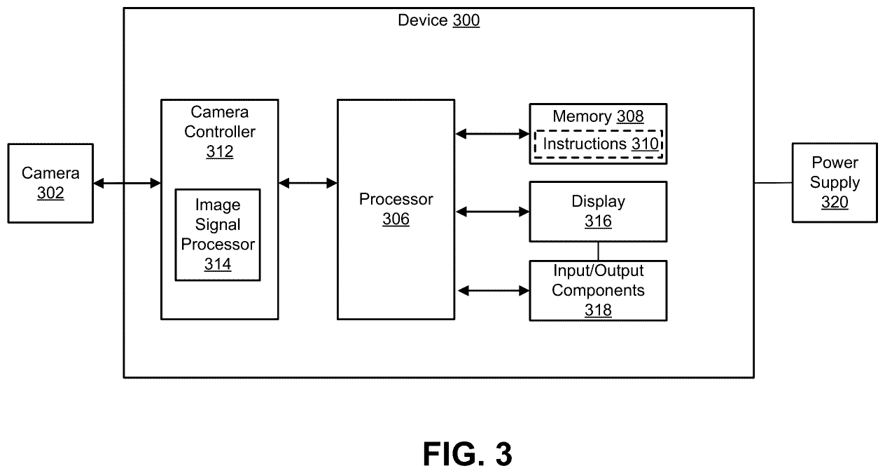

FIG. 3 is a block diagram of an example device 300 that may employ an adaptive camera preview frame rate. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device.

The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF engine or process, an AWB engine or process, and/or an AE engine or process. In some examples, ISP 314 and/or camera controller 312 may include hardware-specific circuits (e.g., an application-specific integrated circuit (ASIC)) configured to perform the AF, AWB, and/or AE engines or processes. In other examples, ISP 314 and/or camera controller 312 may be configured to execute software and/or firmware to perform the AF, AWB, and/or AE engines or processes. When configured in software, code for the AF, AWB, and/or AE engines or processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE engines or processes using a combination of hardware, firmware, and/or software. When configured as software, AF, AWB, and/or AE engines or processes may include instructions that configure ISP 314 and/or camera controller 312 to perform various image processing and device managements tasks, including the techniques of this disclosure.

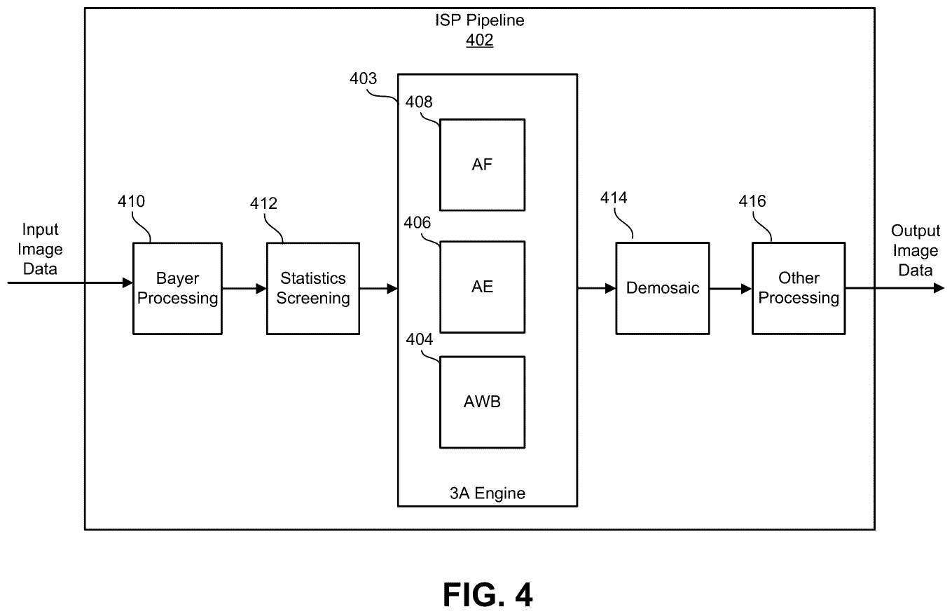

FIG. 4 is a block diagram showing the operation of an image signal processing pipeline 402 of an image signal processor (e.g., the ISP 314). For example, the ISP 314 of FIG. 3 may be configured to execute the image signal processing pipeline 402 to process input image data. The ISP 314 may receive input image data from camera 302 of FIG. 3 and/or an image sensor (not shown) of camera 302. In some examples, the input image data may include color data of the image/frame and/or any other data (e.g., depth data). In the example of FIG. 4, the color data received for the input image data may be in a Bayer format. Rather than capturing red (R), green (G), and blue (B) values for each pixel of an image, image sensors (e.g., an image sensor of camera 302) may use a Bayer filter mosaic (or more generally, a color filter array (CFA)), where each photosensor of a digital image sensor captures a different one of the RGB colors. One example of a filter pattern for a Bayer filter mosaic may include 50% green filters, 25% red filters, and 25% blue filters.

Bayer processing unit 410 may perform one or more initial processing techniques on the raw Bayer data received by the ISP pipeline 402 (e.g., executed by the ISP 314 of FIG. 3), including, for example, subtraction, rolloff correction, bad pixel correction, black level compensation, and/or denoising.

Statistics screening engine 412 may determine Bayer grade or Bayer grid (BG) statistics of the received input image data. In some examples, BG statistics may include a red color to green color ratio (R/G) (which may indicate whether a red tinting exists and the magnitude of the red tinting that may exist in an image) and/or a blue color to green color ratio (B/G) (which may indicate whether a blue tinting exists and the magnitude of the blue tinting that may exist in an image). For example, the (R/G) for an image or a portion/region of an image may be depicted by equation (1) below:

$$R / G = \frac{{\sum }_{n = 1}^{N} Red ( n )}{{\sum }_{n = 1}^{N} Green ( n )} \qquad ( 1 )$$

where the image or a portion/region of the image includes pixels 1−N, each pixel n includes a red value Red (n), a blue value Blue (n), or a green value Green (n) in an RGB space. The (R/G) is the sum of the red values for the red pixels in the image divided by the sum of the green values for the green pixels in the image. Similarly, the (B/G) for the image or a portion/region of the image may be depicted by equation (2) below:

$$B / G = \frac{{\sum }_{n = 1}^{N} Blue ( n )}{{\sum }_{n = 1}^{N} Green ( n )} \qquad ( 2 )$$

In some other example implementations, a different color space may be used, such as Y′UV, with chrominance values UV indicating the color, and/or other indications of a tinting or other color temperature effect for an image may be determined.

The ISP pipeline includes a 3A engine 403, which includes an auto-white balance (AWB) engine 404, an autoexposure (AE) engine 406, and an autofocus (AF) engine 408. The 3A engine 403 can output 3A statistics, including statistics related to autofocus, auto-white balance, and auto-exposure. For example, the AWB engine 404 can analyze information relating to the received image data to determine an illuminant of the scene, from among a plurality of possible illuminants, and may determine an AWB gain to apply to the received image and/or a subsequent image based on the determined illuminant. White balance is a process used to try to match colors of an image with a user's perceptual experience of the object being captured. As an example, the white balance process may be designed to make white objects actually appear white in the processed image and gray objects actually appear gray in the processed image.

An illuminant may include a lighting condition, a type of light, etc. of the scene being captured. In some examples, a user of an image capture device (e.g., such as device 300 of FIG. 3) may select or indicate an illuminant under which an image was captured. In other examples, the image capture device itself may automatically determine the most likely illuminant and perform white balancing based on the determined illuminant (e.g., lighting condition). In order to better render the colors of a scene in a captured image or video, an AWB algorithm on a device and/or camera may attempt to determine the illuminants of the scene and set/adjust the white balance of the image or video accordingly.

During the AWB process by the AWB engine 404, the ISP pipeline 402 may determine or estimate a color temperature for a received frame (e.g., image). The color temperature may indicate a dominant color tone for the image. The true color temperature for a scene being captured in a video or image is the color of the light sources for the scene. If the light is radiation emitted from a perfect blackbody radiator (theoretically ideal for all electromagnetic wavelengths) at a particular color temperature (represented in Kelvin (K)), and the color temperatures are known, then the color temperature for the scene is known. For example, in a Commission Internationale de l'éclairage (CIE) defined color space (from 1931), the chromaticity of radiation from a blackbody radiator with temperatures from 1,000 to 20,000 K is the Planckian locus. Colors on the Planckian locus from approximately 2,000 K to 20,000 K are considered white, with 2,000 K being a warm or reddish white and 20,000 K being a cool or bluish white. Many incandescent light sources include a Planckian radiator (tungsten wire or another filament to glow) that emits a warm white light with a color temperature of approximately 2,400 to 3,100 K.

However, other light sources, such as fluorescent lights, discharge lamps, or light emitting diodes (LEDs), are not perfect blackbody radiators whose radiation falls along the Planckian locus. For example, an LED or a neon sign emit light through electroluminescence, and the color of the light does not follow the Planckian locus. The color temperature determined for such light sources may be a correlated color temperature (CCT). The CCT is the estimated color temperature for light sources whose colors do not fall exactly on the Planckian locus. For example, the CCT of a light source is the blackbody color temperature that is closest to the radiation of the light source. CCT may also be denoted in K.

CCT may be an approximation of the true color temperature for the scene. For example, the CCT may be a simplified color metric of chromaticity coordinates in the CIE 1931 color space. Many devices may use AWB to estimate a CCT for color balancing.

The CCT may be a temperature rating from warm colors (such as yellows and reds below 3200 K) to cool colors (such as blue above 4000 K). The CCT (or other color temperature) may indicate the tinting that will appear in an image captured using such light sources. For example, a CCT of 2700 K may indicate a red tinting, and a CCT of 5000 K may indicate a blue tinting.

Different lighting sources or ambient lighting may illuminate a scene, and the color temperatures may be unknown to the device. As a result, the device may analyze data captured by the image sensor to estimate a color temperature for an image (e.g., a frame). For example, the color temperature may be an estimation of the overall CCT of the light sources for the scene in the image. The data captured by the image sensor used to estimate the color temperature for a frame (e.g., image) may be the captured image itself.

After ISP pipeline 402 determines a color temperature for the scene (such as during performance of AWB), ISP pipeline 402 may use the color temperature to determine a color balance for correcting any tinting in the image. For example, if the color temperature indicates that an image includes a red tinting, ISP pipeline 402 may decrease the red value or increase the blue value for each pixel of the image, e.g., in an RGB space. The color balance may be the color correction (such as the values to reduce the red values or increase the blue values).

Example inputs to AWB engine 404 may include the Bayer grade or Bayer grid (BG) statistics of the received image data determined via statistics screening engine 412, an exposure index (e.g., the brightness of the scene of the received image data), and auxiliary information, which may include the contextual information of the scene based on the audio input (as will be discussed in further detail below), depth information, etc. In some cases, AWB engine 404 may be included within camera controller 312 of FIG. 3 as a separate AWB module.

AE engine 406 may include instructions for configuring, calculating, and/or storing an exposure setting of a camera (e.g., camera 302 of FIG. 3). An exposure setting may include an amount of sensor gain to be applied, an amount of digital gain to be applied, shutter speed and/or exposure time, an aperture setting, and/or an ISO setting to use to capture subsequent images. AE engine 406 may use the audio input and/or the contextual information of the scene based on the audio input to determine and/or apply exposure settings faster. In some cases, AE engine 406 may be included within camera controller 312 of FIG. 3 as a separate AE module.

AF engine 408 may include instructions for configuring, calculating and/or storing an auto focus setting of the camera (e.g., camera 302 of FIG. 3). AF engine 408 may determine the auto focus setting (e.g., an initial lens position, a final lens position, etc.) based on the audio input and/or the contextual information of the scene based on the audio input. In some cases, AF engine 408 may be included within camera controller 312 of FIG. 3 as a separate AF module.

Demosaic processing unit 414 may be configured to convert the processed Bayer image data into RGB values for each pixel of an image. As explained above, Bayer data may only include values for one color channel (R, G, or B) for each pixel of the image. Demosaic processing unit 414 may determine values for the other color channels of a pixel by interpolating from color channel values of nearby pixels. In some ISP pipelines 402, demosaic processing unit 414 may come before AWB, AE, and/or AF engines 404, 406, 408 or after AWB, AE, and/or AF engines 404, 406, 408.

Other processing unit 416 may apply additional processing to the image after AWB, AE, and/or AF engines 404, 406, 408 and/or demosaic processing unit 414. The additional processing may include color, tone, and/or spatial processing of the image.

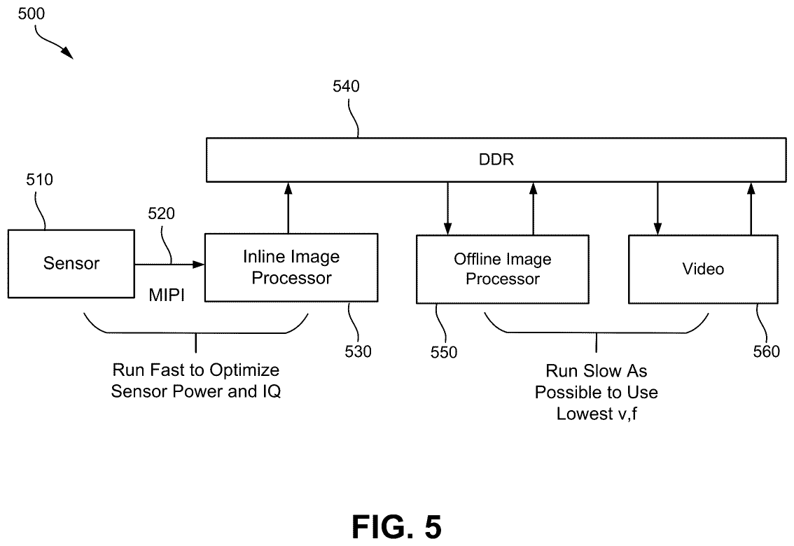

FIG. 5 is a block diagram illustrating an example of data flow in a camera system. In particular, FIG. 5 is a diagram illustrating an example of a system 500 for a camera showing the data flow. In FIG. 5, the system 500 is shown to include a sensor 510 (e.g., a camera sensor subsystem for obtaining image frames capturing scenes), an inline image processor 530 (e.g., image front end (IFE)), an offline image processor 550 (e.g., also referred to as an offline processing engine or image processing engine (IPE)), and a video processor 560. The sensor 510, the inline image processor 530, the offline image processor 550, and the video processor 560 are all shown to be in communication with DDR memory 540.

During operation of the system 500, the sensor 510 can stream pixels of sensor data to the inline image processor 530 (e.g., an image front-end camera component, which can be a component in the SOC) via a Mobile Industry Processor Interface (MIPI) 520. After the inline image processor 530 receives the pixels from the sensor 510, the inline image processor 530 can process the pixels (e.g., by processing the pixels one line at a time). After the inline image processor 530 has processed one or more of the lines of the image frame, the inline image processor 530 can transfer the processed sensor data to the DDR memory 540. The offline image processor 550 can read the image frames from the DDR memory 540. The processing by the inline image processor 530 is referred to as inline processing because the inline image processor 530 processes the pixels in line with the operation of the sensor 510 (e.g., as the pixels are received from the sensor 501 via the MIPI 520).

The timing of the inline image processor 530 may need to be strictly maintained because the timeline of operation of the inline image processor 530 needs to correspond to (e.g., be inline with) the timeline of operation of the sensor 510. As such, if the sensor 510 readout occurs within 8.3 milliseconds, the operation of the inline image processor 530 can also be within 8.3 milliseconds to finish processing all of the pixels it receives from the sensor 510 to be completely inline.

In one or more examples, the output of the inline image processor 530 can be downscaled. For example, if the camera includes a forty-eight (48) megapixel camera sensor, all 48 megapixels of sensor data can streamed to the inline image processor 530. The offline image processor 550 would end up processing all this 48 megapixels, however the video resolution could itself be much less. For example, the resulting video can have a full high definition (FHD) video resolution or an ultra-high definition (UHD) video resolution. The output of inline image processor 530 can downscaled, and then transferred to the DDR memory 540. The offline image processor 550 can operate on this downscale resolution and continue the rest of the image processing.

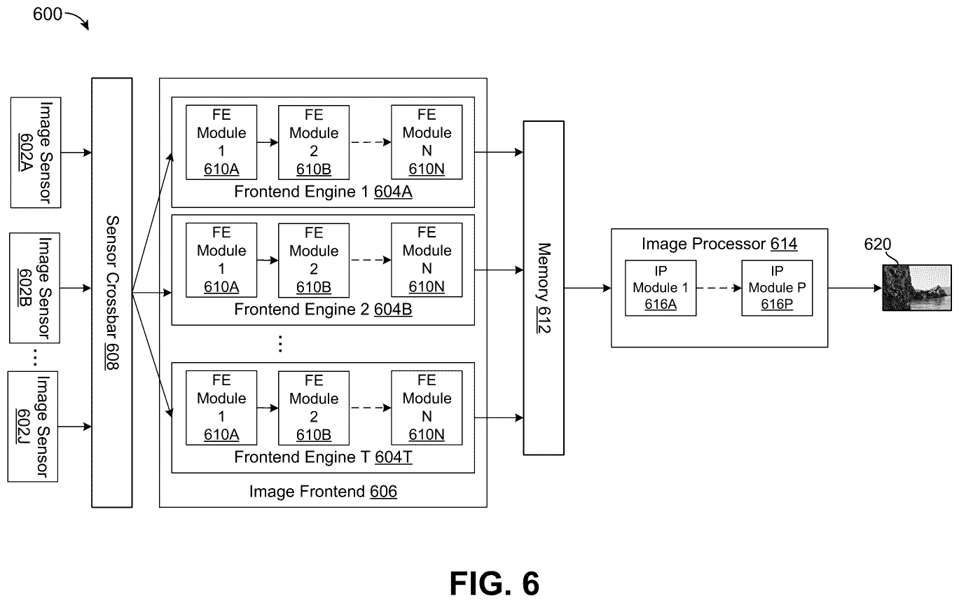

FIG. 6 is a block diagram illustrating an example system 600 for data processing. The system 600 may generate a final image 620 using images captured from any of image sensors 602A, 602B, through 602J (collectively referred to as image sensors 602). In some cases, image sensors 602 may be image sensors 130 of FIG. 1. In some cases, the final image 620 may be generated from images captured by multiple image sensors 602. The image sensors 602 may be coupled to T frontend engines 604A, 604B, through 604T (collectively frontend engines 604, where T can be a value greater than or equal to 0) of an image frontend 606 (e.g., an IFE) via a sensor crossbar 608. In some cases, the image frontend 606 can be similar to or the same as the inline image processor 530 of FIG. 5. The image crossbar 608 may couple each of the image sensors 602 to each of the frontend engines 604 of the image frontend 606. In some cases, as each of the image sensors 602 are coupled to each of the frontend engines 604 of the image frontend 606, any of the frontend engines 604 may be used to pre-process image data from any of the image sensors 602. In some examples, a number of frontend engines 604 included in the image frontend 606 may be based on a number of image sensors 602 that may be used concurrently.

The image frontend 606 may perform real-time pre-processing of full resolution image data as captured by the image sensors 602. To allow for the pre-processing of the full resolution images, the image frontend 606 may include large image buffers (not shown) sufficient to store one or more full resolution images as captured by the image sensors 602. In some cases, the image frontend engines 604 of the image frontend 606 may perform one or more pre-processing operations. The pre-processing operations can include, for example and without limitation, auto-focusing operations, chromatic aberration correction, pixel brightness transformation (e.g., brightness correction, grey scale transformation, etc.), color space conversion, geometric transformation (e.g., rotation, scaling, translation, affine transformation, resizing, etc.), image filtering (e.g., image and/or edge smoothing and/or enhancement, denoising, image sharpening, etc.), image warping, image segmentation, image restoration, image enhancement, lens shading, color correction, black level adjustment, lens distortion correction, faulty pixel replacement, demosaicking, color balancing, compression, interpolation, any other image pre-processing operations, and/or a combination thereof. In some cases, operations that may be performed as a pre-processing operation by a frontend engine 604 may be those operations that should be performed with relatively low-latency, such as for phase detection auto-focusing, or those operations that, when performed at a beginning of an image processing pipeline, can yield a higher image quality, such as for chromatic aberration correction.

In some cases, the frontend engines 604 may include a processing pipeline of N (e.g., two or more) frontend modules 610A, 610B, through 610N (collectively, frontend modules 610) which can apply the one or more pre-processing operations. For a first example, a frontend module, such as frontend module 1 610A, may pre-process images from the image sensors 602 to perform phase detection auto-focus operations. As a second example, another frontend module, such as frontend module 2 610B, may perform chromatic aberration correction operations. In some cases, as any of the frontend engines 604 may be used to pre-process image data from any of the image sensors 602, the frontend engines 604 may all be identical and include the same frontend modules 610. Having identical image frontend engines 604 can help reduce design, test, and production costs as individual frontend engines do not need to be developed, tested, and/or produced for different types of image sensors. Additionally, identical image frontend engines 604 can allow designers more flexibility to select image sensors 602 and customize features for different end products without having to take into account different types of frontend engines 604.

In some cases, while the frontend engines 604 may all include the frontend modules 610 for pre-processing images from any of the image sensors 602, images from some image sensors 602 may not be pre-processed by certain frontend modules 610 of the frontend engines 604. Referring to the first example above, an image sensor, such as image sensor 602A may support phase detection and images generated by image sensor 602A may be pre-processed by a frontend module, such as frontend module 1 610A, which performs phase detection auto-focus operations. Another image sensor, such as image sensor 602B, may not support phase detection and thus images generated by image sensor 602B may not be pre-processed by the frontend module, such as frontend module 1 610A, which performs phase detection auto-focus operations. Referring to the second example, above, lateral chromatic aberration correction operations may be performed, for example by frontend module 2 610B, on images produced by an ultra-wide angle sensor, for example image sensor 602B, but not on images produced by other image sensors, such as image sensor 602A. In some examples, the frontend modules 610 may be software controlled so that the appropriate frontend modules 610 are selected based on which image sensor 602 is providing the image data.

After the frontend modules 610 pre-process the images from the image sensors 602, the pre-processed image may be written to a memory 612. In some cases, the memory 612 can be similar to or the same as the DDR 540 of FIG. 5. The image processor 614 (e.g., an offline processing engine or IPE) may perform offline (e.g., memory to memory) processing of the pre-processed image data from memory 612. In some cases, the image processor 614 can be similar to or the same as the offline image processor 550 of FIG. 5. As the image processor 614 does not need to process images in real-time, the image processor 614 may process an image in portions, for example, by reading a portion of a pre-processed image (e.g., a line or stripe of image data), process that portion, write that processed portion back to memory 612, and then process a next portion of the pre-processed image. After all portions of the image are processed, the processed portions of the final image 620 may be retrieved from memory 612 and output. As the image processor 614 may be able to process images in portions, rather than an entire image at a time, the image processor 614 may include a relatively lower amount of buffer memory as compared to the image frontend 606. Additionally, as the image processor 614 may not process images in real-time, fewer image processor 614 may be used as compared to a number of possible concurrently operating image sensors. In some cases, a single image processor 614 may be used with multiple image sensors 602.

In some cases, the image processor 614 may include a processing pipeline including any number of image processor modules 616A through 616P for performing one or more processing operations on the pre-processed image data. The one or more processing operations can include, for example and without limitation, a filtering operation, a blending operation (e.g., blending pixel values) and/or interpolation operation, a pixel brightness transformation (e.g., brightness correction, grey scale transformation, etc.), a color space conversion, a geometric transformation (e.g., rotation, scaling, translation, affine transformation, resizing, etc.), a cropping operation, a white balancing operation, a denoising operation, an image sharpening operation, chroma sampling, image scaling, a lens correction operation, a segmentation operation, a filtering operation (e.g., filtering in terms of adjustments to the quality of the image in terms of contrast, noise, texture, resolution, etc.), an image warping operation, an image restoration operation, a lens shading operation, a lens distortion correction operation, a faulty pixel replacement operation, a demosaicking operation, a color balancing operation, a smoothing operation, an image enhancement operation, an operation for implementing an image effect or stylistic adjustment, a feature enhancement operation, an image scaling or resizing operation, a color correction operation, a black level adjustment operation, a linearization operation, a gamma correction operation, any other image post-processing operations, and/or a combination thereof.

In some examples, one or more components of system 600 may be integrated into a single chip or integrated circuit. For example, the sensor crossbar 608, image frontend 606, memory 612, and image processor 614 may be integrated into a single image signal processor. As another example, components of system 600 may be integrated into a SoC, as discussed above, with respect to FIG. 1.

As indicated above, as any of the image frontend engines 604 can pre-process images from any image sensor 602, the image frontend engines 604 may be the same (e.g., include the same frontend modules). One issue with having identical image frontend engines is that certain operations may be used by less than all of the image sensors 602. Returning to the previous example, phase detection auto-focus operations and chromatic aberration correction operations may be used by less than all of the image sensors 602 (e.g., just one, or even none, of the image sensors 602). In such cases, replicating redundant frontend modules performing such operations across all of the image frontend engines 604 incurs an area penalty as a physical size of the frontend engines 604 is increased to include circuitry for the respective redundant frontend modules. In some cases, redundant frontend modules may be virtualized across the frontend engines to help reduce or remove the area penalty.

In many cases, when a camera application of a camera is opened, a preview of image frames (referred to as preview image frames, preview frames, or preview images) can be displayed on a display of a device. A rate for the preview of the images (e.g., a preview frame rate) can be fixed (e.g., 60 FPS). A write engine (e.g., DDR memory 540 of FIG. 5) will pick a first image frame from every batch of image frames in the ISP for the preview of the images.

In many cases, there may be little to no change in a scene being captured by a camera (e.g., most scenes do not have a high amount of activity). However, a camera ISP continuously maintains a constant preview frame rate (e.g., 60 FPS) for a preview stream of the images regardless of scene activity. For instance, as noted previously, a preview frame rate for preview of an image frame is typically set to a default setting (e.g., 60 frames per second (FPS), 120 FPS, or other value) regardless of the level of activity within a scene being captured. In one example, for a scene with a high level of movement (e.g., a fast moving object), the default preview frame rate setting can be used to sufficiently capture the high level of movement in an image preview. However, for a scene that involves an idle scene scenario (e.g., a scene with slow moving objects, such as a sunset, or with static objects), the default preview frame rate setting may not be needed for preview frames. For instance, in an example where the default preview frame rate setting is 60 FPS, a lower preview frame rate setting of 30 FPS, 10 FPS, or other reduced frame rate may be sufficient to capture the idle scene scenario.

Maintaining the default or constant preview frame rate can lead to excessive power consumption, computing (e.g., CPU), and memory (e.g., DDR) usage. For example, using a high preview frame rate for idle scene scenarios can be wasteful of camera resources (e.g., computing resources, storage resources, etc.) and power.

To optimize the bandwidth and power impact when capturing image frames of low-activity scenes, it would be beneficial to control the preview frame rate based on a level of activity within the scene. However, currently, there is no logic implemented in cameras to detect an idle scene within a preview stream. Current camera hardware solutions cannot switch to a lowest possible frame rate mode because the display of the camera will also have a fixed configured frame rate (e.g., 60 FPS). As such, in the camera industry today, there is a need for an adaptive camera preview frame rate to conserve camera resources and power.

As previously noted, systems and techniques are described herein for providing an adaptive camera preview frame rate. In one or more examples, for the systems and techniques, the camera can adapt its preview frame rate according to a level of activity detected within a scene being captured. In one or more aspects, the systems and techniques provide a method for conserving camera and display system power, while refreshing an idle scene image. As noted above, the use of a fixed preview frame rate to preview images, when a there is no (or little) change in a scene can result in a large amount of power consumption. The systems and techniques can optimize the preview frame rate to conserve camera resources and power.

In some aspects, a camera statistics (stats) engine (e.g., 3A statistics engine), operating within the ISP of a camera, can be used to determine the amount of change within a scene. An idle scene scenario can be detected (determined) by statistics processing in a camera stats module. The camera stats module can set a number of comparisons between current and previous frame signatures (e.g., based on 3A statistics) for a scene. If the signatures (e.g., 3A statistics) are exactly the same (or only slightly different) during a predetermined fixed period of time, a notification from a camera driver (camx) of the camera to the camera application (Apk) can be sent to reconfigure the preview frame rate to a lower frame rate. The camera driver should check for outstanding calls for new buffer addresses and, if none, the camera driver can enter into an idle scene state.

Display software/hardware frame rates (e.g., FPS) can also be changed dynamically, based on the adjusted preview frame rate. As content-detection logic of the camera driver detects a lower preview frame rate for the camera preview stream, the panel refresh-rate can be adjusted accordingly. The disclosed solution can adjust (e.g., lower) the preview frame rate to conserve bandwidth and power. For example, a sensor frame rate may be 60 FPS, and a preview frame rate (e.g., 60 FPS) can be adjusted to a lower frame rate (e.g., 30 FPS) once an idle scene scenario is detected.

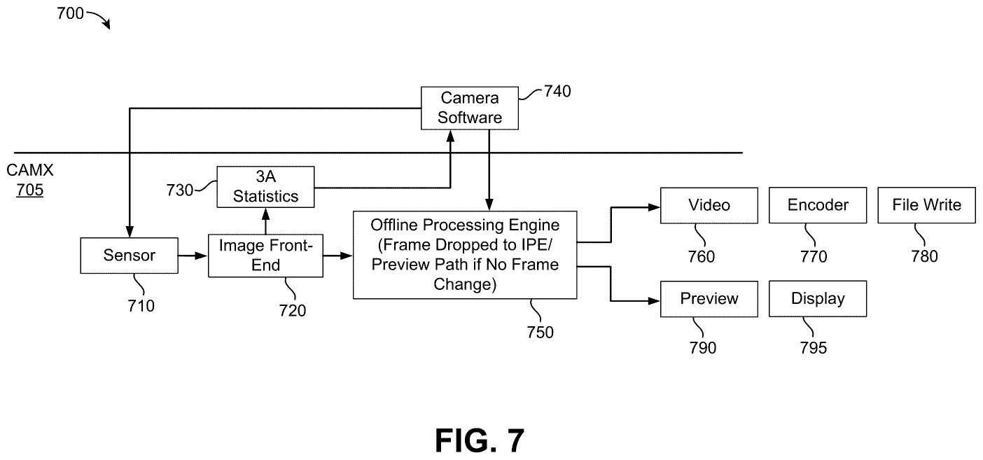

FIG. 7 shows an example of a system (e.g., a camera image capture and processing system) that can adjust (e.g., lower) the preview frame rate when an idle scene scenario is detected. In particular, FIG. 7 is a block diagram illustrating an example of a system 700 that may employ an adaptive camera preview frame rate. In FIG. 7, the system 700 is shown to include a camera driver (camx) 705, an image sensor 710, an image front-end (IFE) 720 (also referred to as an inline image processor), a 3A statistics engine 730, camera software (SW) 740, an offline processing engine 750 (also referred to as an offline image processor or IPE), a video processor 760, an encoder 770, a file system 780, a preview 790, and a display 795.

In one or more examples, the IFE 720 and the offline processing engine 750 may be within an ISP. The 3A statistics engine 730 and the camera SW 740 may also be within the ISP. In one or more examples, the ISP may be the same as (or a component similar to) ISP 154 of FIG. 1, ISP 254 of FIG. 2, ISP 314 of FIG. 3, and/or ISP pipeline 402 of FIG. 4. In one illustrative example, the IFE 720 can be the same as the inline image processor 530 of FIG. 5 and the offline processing engine 750 can be the same as the offline image processor 550. In some cases, the image sensor 710 may include one or more image sensors. In one or more examples, the image sensor 710 is connected to the IFE 720 via a hardwire connection, such as the MIPI as shown in FIG. 2, the MIPI 520 of FIG. 5, and/or the sensor crossbar 608 of FIG. 6.

In one or more examples, the image sensor 710 may be implemented by (or a component similar to) the image sensor 130 of FIG. 1, the image sensor 230 of FIG. 2, the sensor 510 of FIG. 5, and/or the sensor 602 of FIG. 6. The IFE 720 may be implemented by (or a component similar to) the inline image processor 530 of FIG. 5 and/or the image frontend 606 of FIG. 6. The offline processing engine 750 may be implemented by (or a component similar to) the offline image processor 550 of FIG. 5 and/or the image processor 614 of FIG. 6. The offline processing engine 750 may be implemented by (or a component similar to) the video processor 560 of FIG. 5. The display 795 may be implemented by (or a component similar to) the display 316 of FIG. 3.

In one or more examples, during operation of the system 700 of FIG. 7, the image sensor 710 (e.g., which is configured to capture image data, such as light and color) can obtain (e.g., capture or sense) a current image frame of a scene at a sensor frame rate (e.g., 60 FPS). In one or more examples, the scene may include a high level of movement, such as a scene including a fast moving object (e.g., a speeding car), or may include an idle scene scenario, such as a scene including one or more slow moving and/or static objects.

After the sensor 710 has obtained the current image frame of the scene, the sensor can send (e.g., transmit), at the sensor frame rate (e.g., 60 FPS), the current image frame of the scene to the IFE 720 for processing. The IFE 720 can be coupled to or connected to the sensor 710 via a hardwire connection, such as a MIPI (e.g., MIPI 520 of FIG. 5). After the IFE 720 processes the current image frame, the IFE 720 can send (e.g., transmit) the current image frame to the 3A statistics engine 730 for processing.

In some cases, the 3A statistics engine 730 is within the IFE 720 or can be separate from the IFE 720. The 3A statistics engine 730 can determine one or more statistics (referred to as 3A statistics) for the current image frame of the scene. In one or more examples, the 3A statistics engine 730 can run a 3A algorithm to determine the statistics, which can include different types of statistics. For instance, the 3A algorithm can determine statistics (e.g., 3A statistics) associated with autofocus (AF), statistics associated with auto white balance (AWB), and/or statistics associated with auto exposure (AE). Details of AF, AWB, and AE are described with respect to AF 408, AWB 404, and AE 406 of FIG. 4. 3A statistics can be used to perform one or more of the AF, AWB, and/or AE for a current image frame or one or more subsequent frames. According to the systems and techniques described herein, the 3A statistics can also be used to determine whether to adjust a preview frame rate (e.g., based on whether or not the scene includes an idle scene scenario).

After the 3A statistics engine 730 has determined the statistics (e.g., 3A statistics) for the current image frame of the scene, the 3A statistics engine 730 can compare the statistics of the current image frame of the scene with statistics of a previous image frame of the scene (e.g., which was captured by the image sensor 710 a predetermined amount of time prior to the time of the capturing of the current image frame) to determine whether or not the scene includes an idle scene scenario. The 3A statistics engine 730 may determine that the scene includes an idle scene scenario when the difference in one or more of the statistics (e.g., the 3A statistics) of the current image frame with one or more of the statistics (e.g., the 3A statistics) of the previous image frame is below a statistics threshold value for one or more of the statistics. In some cases, the statistics threshold value can be configured based on image quality (IQ) requirements (e.g., with a value of 5, 10, or other value). In one or more examples, each of the different types of statistics (e.g., the 3A statistics) can have a respective statistics threshold value. Conversely, the 3A statistics engine 730 may determine that the scene does not include an idle scene scenario when the difference in one or more of the statistics (e.g., the 3A statistics) of the current image frame with one or more of the statistics (e.g., the 3A statistics) of the previous image frame is equal to or above the statistics threshold value for one or more of the statistics.

If the 3A statistics engine 730 determines that the scene includes in idle scene scenario, then the 3A statistics engine 730 can send (e.g., transmit) a signal (e.g., a command) to the camera SW 740 to configure the offline processing engine 750 to adjust a preview frame rate for the preview 790 of the images from a default preview frame rate (e.g., 60 FPS, 120 FPS, etc.) to a lower preview frame rate (e.g., 10 FPS, 30 FPS, etc.) and to keep the video stream intact. For instance, based on determining that there is an idle scene scenario (e.g., there is no update in the scene), the camera SW 740 (or other component of the system 700) may adjust only the preview frame rate, in which case the video encoder can continue to encode at an encoding frame rate (e.g., 60 FPS). In one illustrative example, assuming a use case configured at 60 FPS, if there is no update in the scene then preview FPS rate can be adjusted to 15 FPS, and video encoding can continue to operate at 60 FPS. In one or more examples, the camera SW 740 is run within the IFE 720.

In one or more examples, when the 3A statistics engine 730 determines that the scene includes in idle scene scenario, the preview frame rate may be adjusted (e.g., lowered) according to an amount of difference in the statistics in one or more of the statistics (e.g., the 3A statistics) of the current image frame with one or more of the statistics (e.g., the 3A statistics) of the previous image frame. For example, if it is determined that one or more of the statistics (e.g., the 3A statistics) of the current image frame differ from one or more of the statistics (e.g., the 3A statistics) of the previous image frame by 30 percent (%), than the preview frame rate may be adjusted (lowered) from the default preview frame rate of 60 FPS to 30 FPS. If it is determined that one or more of the statistics (e.g., the 3A statistics) of the current image frame differ from one or more of the statistics (e.g., the 3A statistics) of the previous image frame by 50%, than the preview frame rate may be adjusted (lowered) from the default preview frame rate of 60 FPS to 10 FPS.

However, if the 3A statistics engine 730 determines that the scene does not include in idle scene scenario, then the 3A statistics engine 730 does not need to send a signal (command) to the camera SW 740 to configure (adjust) the preview frame rate, and the preview frame rate for the camera can simply be maintained to be at the default preview frame rate (e.g., 60 FPS). The IFE 720 can simply send (e.g., transmit) the current image frame of the scene to the offline processing engine 750 for processing.

Regardless of whether the 3A statistics engine 730 determines that the scene includes an idle scene scenario or not, the 3A statistics engine 730 can send (e.g., transmit) the determined statistics (e.g., 3A statistics) for the current image frame of the scene to the camera SW 740. The camera SW 740 can then send (e.g., transmit) a signal (e.g., command) to the image sensor 710 to configure (adjust) its sensor parameters according to the statistics (e.g., 3A statistics) for the current image frame of the scene to optimize the sensing performance for the image sensor 710.

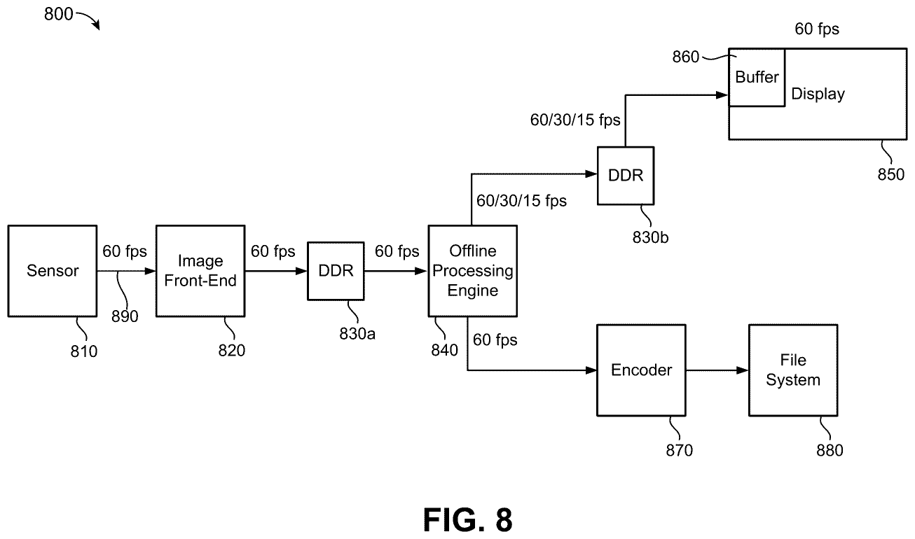

After the IFE 720 has received and processed the current image frame of the scene, the IFE 720 can output the current image frame of the scene for processing by the offline processing engine 750. For example, as described herein, the IFE 720 can output or write the current image frame to a memory device (e.g., a memory such as memory 612 of FIG. 6, which can include a DDR such as DDR 540 of FIG. 5, DDR memory 830b of FIG. 8, etc.), and the offline processing engine 750 can obtain (e.g., read) the current image frame from the memory device. After the offline processing engine 750 has processed the current image frame of the scene, the offline processing engine 750 can send (e.g., transmit) the current image frame of the scene to the video processor 760 for processing and can output the current image frame for processing by a preview 790 for displaying a preview of the image via display 795. For example, as described herein, the offline processing engine 750 can output or write the processed current image frame to the memory device (e.g., a memory such as memory 612 of FIG. 6, which can include a DDR such as DDR 540 of FIG. 5, DDR memory 830b of FIG. 8, etc.), and the preview 790 can obtain (e.g., read) the processed current image frame from the memory device.

As shown in FIG. 7, the offline processing engine 750 can perform a single input-multiple output (SIMO) operation because the offline processing engine 750 has a single input from the IFE 720 (e.g., via the memory device) and multiple outputs to the video processor 760 and the preview 790. The frame rate that the offline processing engine 750 outputs the current image frame of the scene to the video processor 760 (e.g., the video frame rate) may be the same frame rate as (or may be a different frame rate than) the frame rate that the offline processing engine 750 outputs the current image frame of the scene to the preview 790 (referred to as the preview frame rate). For example, when the 3A statistics engine 730 determines that the scene includes an idle scene scenario, the preview frame rate (e.g., 10 FPS) may be a lower frame rate than the video frame rate (e.g., 60 FPS). Conversely, when the 3A statistics engine 730 determines that the scene does not include an idle scene scenario, the preview frame rate (e.g., 60 FPS) may be the same frame rate than the video frame rate (e.g., 60 FPS).

After the video processor 760 has received the current image frame of the scene from the offline processing engine 750, the video processor 760 can process the current image frame of the scene and send (e.g., transmit) the current image of the scene, at a video frame rate, to the encoder 770 for encoding (e.g., compression). The encoder 770 may run at a fixed encoder frame rate (e.g., 30 FPS, 60 FPS, etc.). After the encoder 770 has encoded the current image frame of the scene, the encoder 770 can write the encoded current image frame of the scene to memory in the file system 780.

The preview 790 can receive the current image frame of the scene from the offline processing engine 750 (e.g., via the memory device, such as DDR) at the preview frame rate. The display 795 can display the current image frame of the scene at a display frame rate, which can be the same as the preview frame rate or can be different from (e.g., higher than) the preview frame rate.

FIG. 8 shows an example of a system (e.g., a camera image capture and processing system), showing example frame rates, that can adjust (e.g., lower) the preview frame rate when an idle scene scenario is detected. In particular, FIG. 8 is a is a block diagram illustrating an example of a system 800 that may employ an adaptive camera preview frame rate, where the diagram is showing examples of frame rates within the system 800. In FIG. 8, the system 800 includes an image sensor 810, an image front-end (IFE) 820, a DDR memory 830a, 830b, an offline processing engine 840, a display 850 including a buffer 860, an encoder 870, and a file system 880. In some cases, the DDR memory 830a and the DDR memory 830b are the same DDR memory.

The IFE 820 and the offline processing engine 840 may both be within an ISP. In one or more examples, the ISP may be by (or a component similar to) ISP 154 of FIG. 1, ISP 254 of FIG. 2, ISP 314 of FIG. 3, and/or ISP pipeline 402 of FIG. 4. In some examples, the image sensor 810 can include one or more image sensors. The image sensor 810 may connected to the IFE 820 by a hardwire connection 890, such as the MIPI as shown in FIG. 2, the MIPI 520 of FIG. 5, and/or the sensor crossbar 608 of FIG. 6. In one or more examples, the DDR memory 830a, 830b may be implemented by (or a component similar to) the DDR memory 308 of FIG. 3, DDR 540 of FIG. 5, and/or memory 612 of FIG. 6.

In one or more examples, the image sensor 810 may be implemented by (or a component similar to) the image sensor 130 of FIG. 1, the image sensor 230 of FIG. 2, the sensor 510 of FIG. 5, and/or the sensor 602 of FIG. 6. The IFE 820 may be implemented by (or a component similar to) the inline image processor 530 of FIG. 5 and/or the image frontend 606 of FIG. 6. The offline processing engine 750 may be implemented by (or a component similar to) the offline image processor 550 of FIG. 5 and/or the image processor 614 of FIG. 6. The offline processing engine 840 may be implemented by (or a component similar to) the video processor 560 of FIG. 5. The display 795 may be implemented by (or a component similar to) the display 316 of FIG. 3.

The image sensor 810 can capture image data (e.g., light and color), including one or more image frames at a sensor frame rate (e.g., 60 FPS). For example, the image sensor 810 can obtain (e.g., capture or sense) a current image frame of a scene at the sensor frame rate (e.g., 60 FPS). In one or more examples, the scene may include a high level of movement or activity (e.g., a scene including a fast moving object) or may include an idle scene scenario (e.g., a scene including a slow moving or static object).

The sensor can send (e.g., transmit), at the sensor frame rate (e.g., 60 FPS), the current image frame of the scene via the hardware connection 890 (e.g., MIPI or other connection or interface) to the IFE 820 for processing. The IFE 820 (or a 3A statistics engine, which can be part of or separate from the IFE 720, as described with respect to FIG. 7) can process the current image frame of the scene by determining one or more statistics for the current image frame of the scene (e.g., 3A statistics, which can include different types of statistics). In one or more examples, as described herein (e.g., with respect to FIG. 4), the IFE 820 can run a 3A algorithm to determine statistics associated with AF, statistics associated with AWB, and/or statistics associated with AE.

The IFE 820 (or the 3A statistics engine or camera software, such as camera software 740) can compare the statistics of the current image frame of the scene with statistics of a previous image frame of the scene to determine whether or not the scene includes an idle scene scenario. In one or more examples, the previous image frame of the scene can be captured by the image sensor 810 a predetermined amount of time prior to the time of the capturing of the current image frame. The IFE 820 (or the 3A statistics engine or camera software) may determine that the scene includes an idle scene scenario when the difference in one or more of the statistics (e.g., the 3A statistics) of the current image frame with one or more of the statistics (e.g., the 3A statistics) of the previous image frame is below a statistics threshold value for one or more of the statistics. The IFE 820 (or the 3A statistics engine or camera software) may determine that the scene does not include an idle scene scenario when the difference in one or more of the statistics (e.g., the 3A statistics) of the current image frame with one or more of the statistics (e.g., the 3A statistics) of the previous image frame is equal to or above the statistics threshold value for one or more of the statistics.

When the IFE 820 determines that the scene includes in idle scene scenario, the IFE 820 (or the 3A statistics engine or camera software) can send (e.g., transmit) a signal (e.g., a command) to the offline processing engine 840 to configure (e.g., adjust) a preview frame rate for the preview of the images from a default preview frame rate (e.g., 60 FPS) to a lower preview frame rate (e.g., 30 or 15 FPS). However, when the IFE 820 determines that the scene does not include in idle scene scenario, the preview frame rate may be maintained to be at the default preview frame rate (e.g., 60 FPS).

After the IFE 820 has processed the current image frame of the scene, the IFE 820 can write the current image frame of the scene to the DDR memory 830a at a frame rate (e.g., 60 FPS). The offline processing engine 840 can read the current image frame of the scene from the DDR memory 830a at a frame rate (e.g., 60 FPS). The offline processing engine 840 can then process the current image frame of the scene.

After the offline processing engine 840 has processed the current image frame of the scene, the offline processing engine 840 can send (e.g., transmit) the current image frame of the scene (e.g., at a frame rate of 60 FPS, which may be equal to the sensor frame rate), to the encoder 870 for encoding (e.g., compression). The encoder 870 can run at a fixed encoder frame rate (e.g., 30 FPS, 60 FPS, etc.). After the encoder 870 has encoded the current image frame of the scene, the encoder 870 can write the current image frame of the scene to memory in the file system 880.

The offline processing engine 840 outputs the current image frame of the scene (along with other image frames) at the preview frame rate (e.g., at the adjusted frame rate or at the default frame rate, depending on whether the scene is determined to be an idle scene scenario). For instance, once the offline processing engine 840 has processed the current image frame of the scene, the offline processing engine 840 can write the current image frame of the scene to the DDR memory 830b at the preview frame rate (e.g., at the adjusted frame rate or at the default frame rate). The preview frame rate may vary depending upon the difference in one or more of the statistics (e.g., the 3A statistics) of the current image frame with one or more of the statistics (e.g., the 3A statistics) of the previous image frame. For example, the preview frame rate may be 60 FPS, 30 FPS, 15 FPS, or any other value of FPS that is lower than the default preview frame rate. Accordingly, the number of frames stored in DDR memory 830b can be reduced when image frames of an idle scene scenario are captured.

The display 850 can read the current image frame of the scene from the DDR memory 830b at the preview frame rate (e.g., 60, 30, or 15 FPS). The display 850 can then write the current image frame of the scene to its internal buffer 860. The display can read image frames (including the current image frame of the scene) from its buffer 860, and display the image frames at a display frame rate (e.g., 60 FPS, 30 FPS, etc.), which can be different than or the same as the preview frame rate (e.g., 60 FPS, 30 FPS, 15 FPS, etc.).

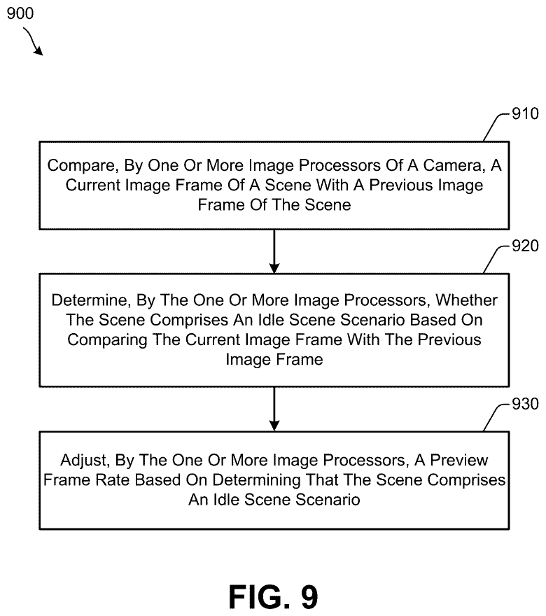

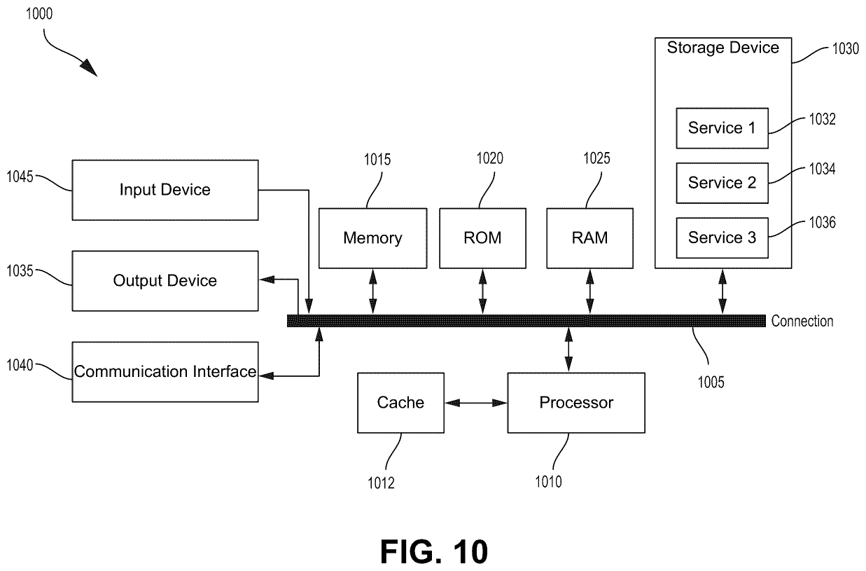

FIG. 9 is a flow chart illustrating an example of a process 900 for an adaptive camera preview frame rate. The process 900 can be performed by a computing device or system, or by a component or system (e.g., a chipset) of the computing device or system. In some aspects, the process 900 can be performed by the system 700 of FIG. 7 and/or the system 800 of FIG. 8, or by a computing device (e.g., a mobile device, camera device, extended reality (XR) device, laptop or desktop computer, a vehicle or computing device of the vehicle, etc.) that includes the system 700 and/or the system 800. One or more of the operations of the process 900 may be implemented as software components (e.g., the camera software 740 of FIG. 7) that are executed and run on one or more processors (e.g., one or more of the IFE 720 of FIG. 7 and/or the offline processing engine 750 of FIG. 7, the IFE 820 of FIG. 8 and/or the offline processing engine 840 of FIG. 8, the processor 1010 of FIG. 10, and/or other processor(s)).

At block 910, the computing device or system (or component thereof) can compare, using one or more image processors of a camera, a current image frame of a scene with a previous image frame of the scene. In some cases, the one or more image processors include at least one image signal processor (ISP). In some examples, the least one ISP includes an online processing engine (e.g., the IFE 720 of FIG. 7, the IFE 820 of FIG. 8, etc.) coupled to an image sensor via a hardwire connection and an offline processing engine (e.g., the offline processing engine 750 of FIG. 7, the offline processing engine 840 of FIG. 8, etc.). In some cases, to compare the current image frame with the previous image frame, the computing device or system (or component thereof) can compare statistics of the current image frame with statistics of the previous image frame. In some aspects, the statistics of the current image frame and the statistics of the previous image frame each include statistics associated with autofocus (AF), statistics associated with auto white balance (AWB), and/or statistics associated with auto exposure (AE) determined using a 3A algorithm.

At block 920, the computing device or system (or component thereof) can determine, using the one or more image processors, whether the scene comprises an idle scene scenario based on comparing the current image frame with the previous image frame. In some cases, the computing device or system (or component thereof) can determine, using the one or more image processors, the scene comprises the idle scene scenario based on a difference in one or more of the statistics of the current image frame with one or more of the statistics of the previous image frame being greater than one or more threshold values for the statistics. Referring to FIG. 8 as an illustrative example, the IFE 820 (or the 3A statistics engine or camera software, such as camera software 740) can compare the statistics of a current image frame of a scene with statistics of a previous image frame of the scene to determine whether or not the scene includes an idle scene scenario.

In some cases, a value of the adjusted preview frame rate is based on an amount of the difference in the one or more of the statistics of the current image frame with the one or more of the statistics of the previous image frame. In one illustrative example, if it is determined that one or more of the statistics (e.g., the 3A statistics) of the current image frame differ from one or more of the statistics (e.g., the 3A statistics) of the previous image frame by 30 percent (%), than the preview frame rate may be lowered from a default preview frame rate of 60 FPS to 30 FPS. In another illustrative example, if it is determined that one or more of the statistics (e.g., the 3A statistics) of the current image frame differ from one or more of the statistics (e.g., the 3A statistics) of the previous image frame by 50%, than the preview frame rate may be adjusted (lowered) from the default preview frame rate of 60 FPS to 10 FPS.

At block 930, the computing device or system (or component thereof) can adjust, by the one or more image processors, a preview frame rate based on determining that the scene comprises an idle scene scenario. For instance, adjusting the preview frame rate can include adjusting the preview frame rate to a lower rate than a default preview frame rate. Referring to FIG. 8 as an illustrative example, if the IFE 820 determines that the scene includes in idle scene scenario, then the IFE 820 (or the 3A statistics engine or camera software) can send (e.g., transmit) a signal (e.g., a command) to the offline processing engine 840 to configure (e.g., adjust) a preview frame rate for the preview of the images from a default preview frame rate (e.g., 60 FPS) to a lower preview frame rate (e.g., 30 or 15 FPS). In some cases, software can cause the one or more image processors to adjust the preview frame rate. Referring to FIG. 7 as an illustrative example, if the 3A statistics engine 730 determines that the scene includes in idle scene scenario, then the 3A statistics engine 730 can send (e.g., transmit) a signal (e.g., a command) to the camera SW 740 to configure the offline processing engine 750 to adjust a preview frame rate for the preview 790 of the images from a default preview frame rate (e.g., 60 FPS, 120 FPS, etc.) to a lower preview frame rate (e.g., 10 FPS, 30 FPS, etc.).

As described herein, the preview frame rate is a rate of output of preview frames from the one or more image processors (e.g., from the ISP, such as the offline processing engine 750 of FIG. 7, the offline processing engine 840 of FIG. 8, etc.). The previous image frame and the current image frame can be captured using an image sensor at a sensor frame rate, where the sensor frame rate is higher than the adjusted preview frame rate (e.g., the sensor frame rate can be at 60 FPS, and the adjusted preview frame rate can be at 30 FPS). In some cases, the computing device or system (or component thereof) can capture, using the image sensor, the previous image frame of the scene and the current image frame of the scene at the sensor frame rate. The computing device or system (or component thereof) can receive, using the one or more processors (e.g., the IFE 720 of FIG. 7, the IFE 820 of FIG. 8, etc.), the previous image frame and the current image frame at the sensor frame rate and can output, from the one or more image processors (e.g., from the ISP, such as the offline processing engine 750 of FIG. 7, the offline processing engine 840 of FIG. 8, etc.), the preview frames to a memory device (e.g., the DDR 830b of FIG. 8) at the adjusted preview frame rate. In some cases, the computing device or system (or component thereof) can output, from the one or more image processors (e.g., from the ISP, such as the offline processing engine 750 of FIG. 7, the offline processing engine 840 of FIG. 8, etc.), the previous image frame and the current image frame to an encoder (e.g., the encoder 870 of FIG. 8) at the sensor frame rate.

The computing device or system (or component thereof) can read the preview frames from the memory device at the adjusted preview frame rate. For example, a display (e.g., the display 850 of FIG. 8) of the computing device can read the preview frames from the memory device at the adjusted preview frame rate. In some cases, the display can store the read preview frames in a buffer (e.g., the buffer 860 of FIG. 8). The computing device or system (or component thereof) can display, using the display (e.g., the display 850 of FIG. 8) the preview frames read from the memory device at a display frame rate. In some cases, the display frame rate is equal to the adjusted preview frame rate. In other cases, the display frame rate is higher than the adjusted preview frame rate.

As noted above, the process 900 may be performed by one or more computing devices or apparatuses. In some illustrative examples, the process 900 can be performed by the image capture and processing system 100 of FIG. 1, the device 300 of FIG. 3, the system 700 of FIG. 7, the system 800 of FIG. 8, and/or one or more computing devices or systems (e.g., the computing system 1000 of FIG. 10). In some cases, such a computing device or apparatus may include a processor, microprocessor, microcomputer, or other component of a device that is configured to carry out the steps of the process 900. In some examples, such computing device or apparatus may include one or more sensors configured to capture image data. For example, the computing device can include a smartphone, a head-mounted display, a mobile device, a camera, a tablet computer, or other suitable device. In some examples, such computing device or apparatus may include a camera configured to capture one or more images or videos. In some cases, such computing device may include a display for displaying images. In some examples, the one or more sensors and/or camera are separate from the computing device, in which case the computing device receives the sensed data. Such computing device may further include a network interface configured to communicate data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 900 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 900 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 10 is a diagram illustrating an example of a system for implementing certain aspects of the present technology. In particular, FIG. 10 illustrates an example of computing system 1000, which can be for example any computing device making up internal computing system, a remote computing system, a camera, or any component thereof in which the components of the system are in communication with each other using connection 1005. Connection 1005 can be a physical connection using a bus, or a direct connection into processor 1010, such as in a chipset architecture. Connection 1005 can also be a virtual connection, networked connection, or logical connection.

In some embodiments, computing system 1000 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1000 includes at least one processing unit (CPU or processor) 1010 and connection 1005 that couples various system components including the memory unit 1015, such as read-only memory (ROM) 1020 and random access memory (RAM) 1025 to processor 1010. Computing system 1000 can include a cache 1012 of high-speed memory connected directly with, in close proximity to, or integrated as part of processor 1010.

Processor 1010 can include any general purpose processor and a hardware service or software service, such as services 1032, 1034, and 1036 stored in storage device 1030, configured to control processor 1010 as well as a special-purpose processor where software instructions are incorporated into the actual processor design. Processor 1010 may essentially be a completely self-contained computing system, containing multiple cores or processors, a bus, memory controller, cache, etc. A multi-core processor may be symmetric or asymmetric.

To enable user interaction, computing system 1000 includes an input device 1045, which can represent any number of input mechanisms, such as a microphone for speech, a touch-sensitive screen for gesture or graphical input, keyboard, mouse, motion input, speech, etc. Computing system 1000 can also include output device 1035, which can be one or more of a number of output mechanisms. In some instances, multimodal systems can enable a user to provide multiple types of input/output to communicate with computing system 1000. Computing system 1000 can include communications interface 1040, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1040 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1030 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1030 can include software services, servers, services, etc., that when the code that defines such software is executed by the processor 1010, it causes the system to perform a function. In some embodiments, a hardware service that performs a particular function can include the software component stored in a computer-readable medium in connection with the necessary hardware components, such as processor 1010, connection 1005, output device 1035, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” means A, B, or A and B. In another example, claim language reciting “at least one of A, B, and C” means A, B, C, or A and B, or A and C, or B and C, or A and B and C. The language “at least one of” a set and/or “one or more” of a set does not limit the set to the items listed in the set. For example, claim language reciting “at least one of A and B” can mean A, B, or A and B, and can additionally include items not listed in the set of A and B.

Claim language or other language reciting “at least one processor configured to” and/or “at least one processor being configured to” indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined system or component (e.g., a system-on-chip).

Illustrative aspects of the disclosure include:

Aspect 1. An apparatus for processing image data, the apparatus comprising: at least one processor coupled to at least one memory device and configured to: compare a current image frame of a scene with a previous image frame of the scene; determine whether the scene comprises an idle scene scenario based on comparing the current image frame with the previous image frame; and adjust a preview frame rate based on determining that the scene comprises an idle scene scenario.

Aspect 2. The apparatus of Aspect 1, wherein, to adjust the preview frame rate, the at least one processor is configured to adjust the preview frame rate to a lower rate than a default preview frame rate.

Aspect 3. The apparatus of any one of Aspects 1 or 2, wherein the preview frame rate is a rate of output of preview frames from the at least one processor.

Aspect 4. The apparatus of Aspect 3, wherein the previous image frame and the current image frame are captured using an image sensor at a sensor frame rate, the sensor frame rate being higher than the adjusted preview frame rate.

Aspect 5. The apparatus of Aspect 4, further comprising the image sensor, the image sensor configured to capture the previous image frame of the scene and the current image frame of the scene at the sensor frame rate.

Aspect 6. The apparatus of any one of Aspects 4 or 5, wherein the at least one processor is configured to: receive the previous image frame and the current image frame at the sensor frame rate; and output the preview frames to the at least one memory device at the adjusted preview frame rate.

Aspect 7. The apparatus of Aspect 6, further comprising: a display device configured to read the preview frames from the at least one memory device at the adjusted preview frame rate.

Aspect 8. The apparatus of Aspect 7, wherein the display device is configured to display the preview frames read from the at least one memory device at a display frame rate.

Aspect 9. The apparatus of Aspect 8, wherein the display frame rate is equal to the adjusted preview frame rate.

Aspect 10. The apparatus of Aspect 8, wherein the display frame rate is higher than the adjusted preview frame rate.

Aspect 11. The apparatus of any one of Aspects 6 to 10, wherein the at least one processor is configured to: output the previous image frame and the current image frame to an encoder at the sensor frame rate.

Aspect 12. The apparatus of any one of Aspects 1 to 11, wherein, to compare the current image frame with the previous image frame, the at least one processor is configured to comparing statistics of the current image frame with statistics of the previous image frame.

Aspect 13. The apparatus of Aspect 12, wherein the at least one processor is configured to determine the scene comprises the idle scene scenario based on a difference in one or more of the statistics of the current image frame with one or more of the statistics of the previous image frame being greater than one or more threshold values for the statistics.

Aspect 14. The apparatus of Aspect 13, wherein a value of the adjusted preview frame rate is based on an amount of the difference in the one or more of the statistics of the current image frame with the one or more of the statistics of the previous image frame.

Aspect 15. The apparatus of any one of Aspects 12 to 14, wherein the statistics of the current image frame and the statistics of the previous image frame each comprise at least one of statistics associated with autofocus (AF), statistics associated with auto white balance (AWB), or statistics associated with auto exposure (AE) determined using a 3A algorithm.

Aspect 16. The apparatus of any one of Aspects 1 to 15, wherein the at least one processor includes at least one image signal processor (ISP).

Aspect 17. The apparatus of Aspect 16, wherein the least one ISP comprises an online processing engine coupled to an image sensor via a hardwire connection and an offline processing engine.

Aspect 18. The apparatus of any one of Aspects 1 to 17, further comprising the at least one memory device.

Aspect 19. A method for processing image data, the method comprising: comparing, by one or more image processors of a camera, a current image frame of a scene with a previous image frame of the scene; determining, by the one or more image processors, whether the scene comprises an idle scene scenario based on comparing the current image frame with the previous image frame; and adjusting, by the one or more image processors, a preview frame rate based on determining that the scene comprises an idle scene scenario.

Aspect 20. The method of Aspect 19, wherein adjusting the preview frame rate comprises adjusting the preview frame rate to a lower rate than a default preview frame rate.

Aspect 21. The method of any one of Aspects 19 or 20, wherein the preview frame rate is a rate of output of preview frames from the one or more image processors.

Aspect 22. The method of Aspect 21, wherein the previous image frame and the current image frame are captured using an image sensor at a sensor frame rate, the sensor frame rate being higher than the adjusted preview frame rate.

Aspect 23. The method of Aspect 22, further comprising capturing, using the image sensor, the previous image frame of the scene and the current image frame of the scene at the sensor frame rate.

Aspect 24. The method of any one of Aspects 22 or 23, further comprising: receiving the previous image frame and the current image frame at the sensor frame rate; and outputting, from the one or more image processors, the preview frames to a memory device at the adjusted preview frame rate.

Aspect 25. The method of Aspect 24, further comprising: reading the preview frames from the memory device at the adjusted preview frame rate.

Aspect 26. The method of Aspect 25, further comprising displaying the preview frames read from the memory device at a display frame rate.

Aspect 27. The method of Aspect 26, wherein the display frame rate is equal to the adjusted preview frame rate.

Aspect 28. The method of Aspect 26, wherein the display frame rate is higher than the adjusted preview frame rate.

Aspect 29. The method of any one of Aspects 24 to 28, further comprising: outputting, from the one or more image processors, the previous image frame and the current image frame to an encoder at the sensor frame rate.

Aspect 30. The method of any one of Aspects 19 to 29, wherein comparing the current image frame with the previous image frame comprises comparing statistics of the current image frame with statistics of the previous image frame.

Aspect 31. The method of Aspect 30, further comprising determining, by the one or more image processors, the scene comprises the idle scene scenario based on a difference in one or more of the statistics of the current image frame with one or more of the statistics of the previous image frame being greater than one or more threshold values for the statistics.

Aspect 32. The method of Aspect 31, wherein a value of the adjusted preview frame rate is based on an amount of the difference in the one or more of the statistics of the current image frame with the one or more of the statistics of the previous image frame.

Aspect 33. The method of any one of Aspects 30 to 32, wherein the statistics of the current image frame and the statistics of the previous image frame each comprise at least one of statistics associated with autofocus (AF), statistics associated with auto white balance (AWB), or statistics associated with auto exposure (AE) determined using a 3A algorithm.

Aspect 34. The method of any one of Aspects 19 to 33, wherein the one or more image processors include at least one image signal processor (ISP).

Aspect 35. The method of Aspect 34, wherein the least one ISP comprises an online processing engine coupled to an image sensor via a hardwire connection and an offline processing engine.

Aspect 36. A non-transitory computer-readable storage medium comprising instructions stored thereon which, when executed by at least one processor, causes the at least one processor to perform operations according to any one of Aspects 19 to 35.

Aspect 37. An apparatus for processing image data, comprising one or more means for performing operations according to any one of Aspects 19 to 35.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for processing image data, the apparatus comprising:
at least one processor coupled to at least one memory device and configured to:
compare a current image frame of a scene with a previous image frame of the scene;
determine whether the scene comprises an idle scene scenario based on comparing the current image frame with the previous image frame; and
adjust a preview frame rate based on determining that the scene comprises an idle scene scenario.

2. The apparatus of claim 1, wherein, to adjust the preview frame rate, the at least one processor is configured to adjust the preview frame rate to a lower rate than a default preview frame rate.

3. The apparatus of claim 1, wherein the preview frame rate is a rate of output of preview frames from the at least one processor.

4. The apparatus of claim 3, wherein the previous image frame and the current image frame are captured using an image sensor at a sensor frame rate, the sensor frame rate being higher than the adjusted preview frame rate.

5. The apparatus of claim 4, further comprising the image sensor, the image sensor configured to capture the previous image frame of the scene and the current image frame of the scene at the sensor frame rate.

6. The apparatus of claim 4, wherein the at least one processor is configured to:
receive the previous image frame and the current image frame at the sensor frame rate; and
output the preview frames to the at least one memory device at the adjusted preview frame rate.

7. The apparatus of claim 6, further comprising:
a display device configured to read the preview frames from the at least one memory device at the adjusted preview frame rate.

8. The apparatus of claim 7, wherein the display device is configured to display the preview frames read from the at least one memory device at a display frame rate.

9. The apparatus of claim 8, wherein the display frame rate is equal to the adjusted preview frame rate.

10. The apparatus of claim 8, wherein the display frame rate is higher than the adjusted preview frame rate.

11. The apparatus of claim 6, wherein the at least one processor is configured to:
output the previous image frame and the current image frame to an encoder at the sensor frame rate.

12. The apparatus of claim 1, wherein, to compare the current image frame with the previous image frame, the at least one processor is configured to comparing statistics of the current image frame with statistics of the previous image frame.

13. The apparatus of claim 12, wherein the at least one processor is configured to determine the scene comprises the idle scene scenario based on a difference in one or more of the statistics of the current image frame with one or more of the statistics of the previous image frame being greater than one or more threshold values for the statistics.

14. The apparatus of claim 13, wherein a value of the adjusted preview frame rate is based on an amount of the difference in the one or more of the statistics of the current image frame with the one or more of the statistics of the previous image frame.

15. The apparatus of claim 12, wherein the statistics of the current image frame and the statistics of the previous image frame each comprise at least one of statistics associated with autofocus (AF), statistics associated with auto white balance (AWB), or statistics associated with auto exposure (AE) determined using a 3A algorithm.

16. The apparatus of claim 1, wherein the at least one processor includes at least one image signal processor (ISP).

17. The apparatus of claim 16, wherein the least one ISP comprises an online processing engine coupled to an image sensor via a hardwire connection and an offline processing engine.

18. The apparatus of claim 1, further comprising the at least one memory device.

19. A method for processing image data, the method comprising:
comparing, by one or more image processors of a camera, a current image frame of a scene with a previous image frame of the scene;
determining, by the one or more image processors, whether the scene comprises an idle scene scenario based on comparing the current image frame with the previous image frame; and
adjusting, by the one or more image processors, a preview frame rate based on determining that the scene comprises an idle scene scenario.

20. The method of claim 19, wherein adjusting the preview frame rate comprises adjusting the preview frame rate to a lower rate than a default preview frame rate.

21. The method of claim 19, wherein the preview frame rate is a rate of output of preview frames from the one or more image processors.

22. The method of claim 21, wherein the previous image frame and the current image frame are captured using an image sensor at a sensor frame rate, the sensor frame rate being higher than the adjusted preview frame rate.

23. The method of claim 22, further comprising capturing, using the image sensor, the previous image frame of the scene and the current image frame of the scene at the sensor frame rate.

24. The method of claim 22, further comprising:
receiving the previous image frame and the current image frame at the sensor frame rate; and
outputting, from the one or more image processors, the preview frames to a memory device at the adjusted preview frame rate.

25. The method of claim 24, further comprising:
reading the preview frames from the memory device at the adjusted preview frame rate.

26. The method of claim 25, further comprising displaying the preview frames read from the memory device at a display frame rate.

27. The method of claim 26, wherein the display frame rate is one of equal to the adjusted preview frame rate or higher than the adjusted preview frame rate.

28. The method of claim 24, further comprising:
outputting, from the one or more image processors, the previous image frame and the current image frame to an encoder at the sensor frame rate.

29. The method of claim 19, wherein comparing the current image frame with the previous image frame comprises comparing statistics of the current image frame with statistics of the previous image frame.

30. The method of claim 19, wherein the one or more image processors include at least one image signal processor (ISP).
